(19) United States
(12) Patent Application Publication
(10) Pub. No.: US 2025/0028725 A1
(43) Pub. Date: Jan. 23, 2025

(54) Shard Optimization for Parameter-Based Indices

(71) Applicant: ELASTICSEARCH B.V., Amsterdam (NL)

(72) Inventors: David Christopher Turner, Otley (GB); Henning Andersen, Silkeborg (DK); Jim Ferenczi, Paris (FR); Francisco Fernandez Castano, Utrecht (NL); Yannick Welsch, Junglinster (LU); Tanguy Leroux, Guerande (FR); Armin Braun, Schwyz (CH); Jason Tedor, Avon, OH (US)

(73) Assignee: ELASTICSEARCH B.V., Amsterdam (NL)

(21) Appl. No.: 18/909,830

(22) Filed: Oct. 8, 2024

Related U.S. Application Data
(63) Continuation of application No. 17/530,944, filed on Nov. 19, 2021, now abandoned.

(51) Int. Cl. G06F 16/2455; G06F 16/22; G06F 16/23

(52) U.S. Cl. CPC G06F 16/24557; G06F 16/2272; G06F 16/2358

(57) ABSTRACT

Methods and systems for shard optimized database queries using parameter-based indexes are provided. Exemplary methods include: receiving a database query that includes an index parameter and an index parameter range. A parameter table is accessed that contains an association between the parameter and parameter range and a shard identifier. Based on the parameter type and the range identified in the query, the relevant shards are identified, and the database query is limited to processing these shards.

### PRIORITY CLAIM

The present application is a continuation application of U.S. patent application Ser. No. 17/530,944, filed on Nov. 19, 2021, the entirety of which is incorporated herein by reference.

### TECHNICAL FIELD

This disclosure is related to the technical field technology of database systems, database management, and the use thereof. More specifically, the technology is related to new and innovative use of database systems for efficiently querying a database that is deployed across multiple shards on local and remote nodes.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

In the past, databases would be split into shards. Typically, a shard is a horizontal slice of the database. These shards can be located on different nodes to provide additional computational resources for accessing data and other database maintenance functions. A node is typically a computational resource that can be connected to other nodes by a network. Also, a node can be a virtual computer and operating system and database residing on another node utilizing the same hardware. Additionally, the database or a subset of database shards can be replicated to provide system redundancy. The described configuration can have drawbacks. First, a database query or search will have to go out to all the nodes if it does not have any a priori information not to search a shard on a node and will take longer to conclude as a result. Another drawback is that this architecture can require a lot of resources, including I/O to read from a storage device, network bandwidth between each node, wait time if a node's data is stored in a slow media, resources for uncompressing compressed database files if compressed, resources to unencrypt encrypted files. Further, problems and delays can occur if a node is inoperative or unable to communicate with the network and a request fails. Logic and processing for handling a non-responsive node also needs to be provided.

What is needed is database systems, architectures, and database methods that minimize the need to access and search nodes that do not contain relevant data.

### SUMMARY

A method of and a system for efficient selective searching database shards based on parameters and parameter ranges. Database queries include a parameter and parameter range which is used to determine which shards are relevant to the search and the associated node on which a shard is located. A parameter table is maintained that lists the parameters associated with each shard and a range for each parameter. This table is searched to find only the relevant shards that need to be queried. A query is sent out to the nodes, holding the relevant shards. The responses from the nodes are combined to provide a query response.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF DRAWINGS

Exemplary embodiments are illustrated by way of example and not limitation in the figures of the accompanying drawings, in which like references indicate similar elements.

FIG. 1-A block diagram of a prior art database system comprising nodes and shards of the database.

FIG. 2A-A block diagram of a prior art database system comprising optimized shard searches of the database.

FIG. 2B-A table for parameter and range-based lookup of shards and nodes.

FIG. 3-A block diagram for parameter-optimized shard database searches.

FIG. 4-A block diagram for updating a parameter table.

FIG. 5-A schematic diagram of an example computing device that can be utilized to implement aspects of the present technology.

### DETAILED DESCRIPTION OF EXEMPLARY EMBODIMENTS

Exemplary embodiments are illustrated by example and not by limitation in the figures of the accompanying drawings, in which like references indicate similar elements.

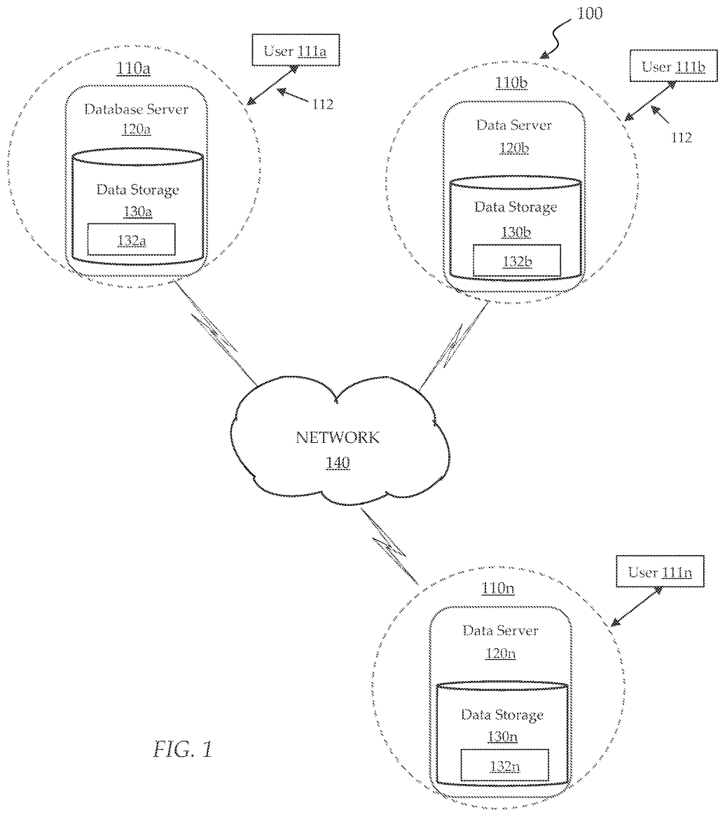

FIG. 1 shows the configuration of a prior art database system 100. The system includes multiple database system nodes 110a-110n, where the database is distributed between shards on each node. Each node contains a Database Server 120a-120n which includes the computational machinery, software, and storage for the database system. The Data Storage 130a-130n provides non-volatile memory for the Database Server 120a-120n. This includes operating system software, GUI, networking software, database management software, and database storage 132a-132n, including a database index. Each database storage 132a-132n can be a shard of the full database, a replica of the database, or a replica of a shard of the database.

Query requests can be generated by a user 111a-111n. The database server 120a-120n on each node 110a-110n typically process the query, sending any required requests to other nodes 110a-110n, gathering the node responses and forming a query response. The query response is then passed to the user 111a-111n making the request.

Some queries can require searching all the shards 116a-116n. If any one of the nodes is down, then the query can fail. Further, some of the shards may be compressed and require computational resources to be decompressed and recompressed. All these factors can cause a database query to be slow and be resource intensive.

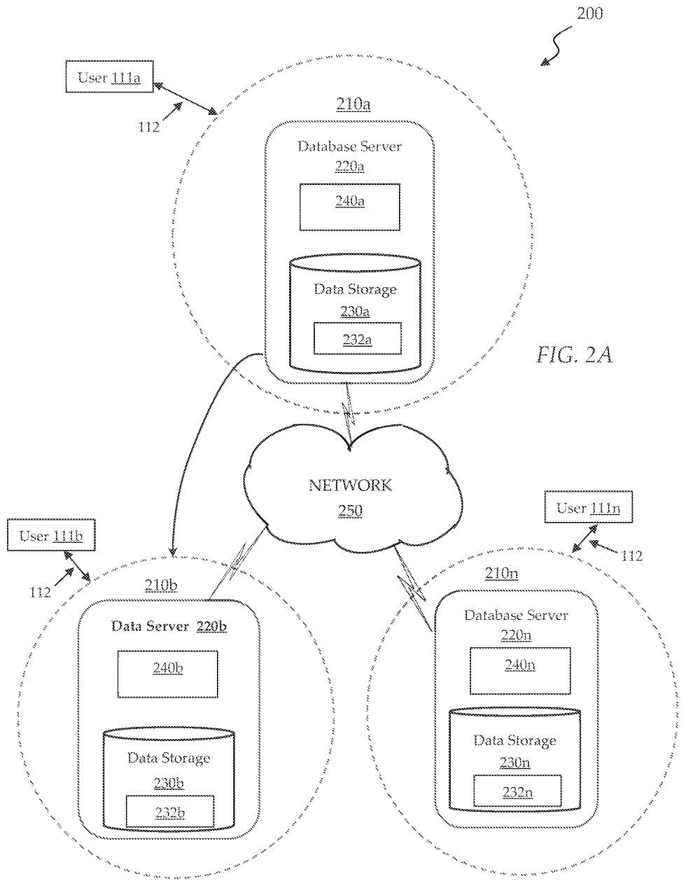

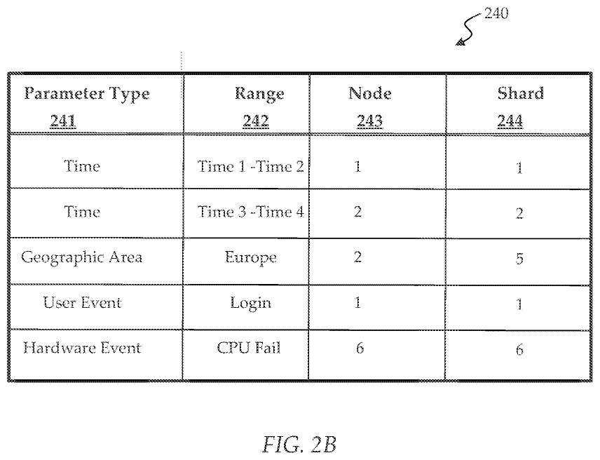

Referring to FIG. 2A, a database system that is capable of parameter-based index searches is shown. The system is comprised of a coordinating database server 220a and additional database servers 220b-n. Note, any of the database servers can function as the coordinating database server. As shown, these additional database servers can reside on different nodes that have their own computing and storage resources holding shards of the database. However, not shown is that the node can be a virtual system where computational hardware resources and storage resources are divided between multiple virtual machines running virtual operating systems.

Additionally, where the specification references “shards”, the term is equally applicable to other data-segmentation. The inventive concept equally applies to data-segmentations including but are not limited to shards, data partitions, disk partitions, data segments, data blocks, virtual implementations of the mentioned data-segmentations or any other data structure that can be searched.

In one embodiment, any of the nodes can receive a query request 112 from a user 111a-111n. Each node 210a-210n can have a parameter table 240a-240n. Any of the nodes 210n can receive a query request 112 and the associated Data Server 220n serve the request to other nodes 210n that may hold parts of the database.

A database query request 112 can include but is not limited to an index parameter and an index parameter criteria. For example, the index parameter can be “Time” and the query request 112 is for the index parameter criteria for a time range or all events X that occurred in the time range of last week. The “index parameter criteria” can include but are not limited to time ranges, locations, user events, server hardware events or criteria, and operating system events. The database software will be configured to search the parameter table 240a for the data-segments that have a time range of within the last week. (See description of parameter table 240 below). Each table row that has a time parameter is checked. If the time criteria falls within the range for that entry, the data-structure is relevant to the query and the data-structure identifier is added to a list or other data structure to be used in a query 112. The data structure identifier can be a shard or partition. In some embodiments, the parameter table 240a can include node information associated with the data-structure. If there is not an overlap, then that data-structure does not need to be searched as part of the query and thereby saving processing time and I/O resources.

One of the nodes 210a-210n can act as the coordinating database server 220a. The coordinating database server 220a is responsible for updating the parameter table 240a and distributing copies of the table 240a to all the database servers 220b-220n. New copies of the parameter table can be sent to the database servers 220b-220n if the parameter table 240a on the coordinating server 220a is updated. For example, if the node 210a is the coordinating node, it usually has the data-structure 232a which is currently being updated. Parts of the database 232b-232n on other nodes that are not being updated will be indexed and will be immutable, not changing. Thus, these parameter tables 240b-240n will not be updated and thus these nodes will not need to provide parameter updates to the coordinating database server 210a.

Next, the data-structures matching the time range to send database queries to the related nodes. The database servers 220a-220n on the nodes 210a-210n will search their associated data-structures and send the results back to the node serving the query where the node serving the query will merge all the responses together.

Referring to FIG. 2B, one embodiment of a parameter table 240 is disclosed and described. The table 240 is utilized by methods and systems performing database queries 112 to determine the relevant data-structures 232a-232n to be searched. The methods can use the one or more parameters to determine which data-structures meet the parameter criteria, the relevant data-structures. As shown, a Parameter column 241 indicates the type of parameter that could be included in a database query 112. The table includes a column for the associated criteria 242 of the Parameter 241 for a data-structure. A non-limiting example of Parameters type includes Time, Geographic Area, User Events, and Hardware Events. These parameters are used in a database query 112 along with the Criteria 242 to limit the query 112 to only relevant data-structures 232a-232n. For each Criteria 242, there can be an associated node identifier 243 and Data-structure identifier 244. The Node column 243 can identify the node for communication with the associated data-structure. The Data-structure column 244 identifies an associated data-structure (shard) identifier. The node information does not have to be stored in the parameter table. In some embodiments, the node information is not stored in the parameter table and is stored elsewhere in the data servers.

Each row in the parameter table 240a-240n can have duplicate values of the data-structure identifier 244. One row can have time Parameter 241 and Criteria 242 for a Data-structure identifier 244. Another row can have a geography Parameter 241 and Criteria 242 for the same Data-structure identifier 244.

Some embodiments of the parameter table include node information. In other embodiments, the node information is maintained separately. The node identifier column 243 within the parameter table 240 can include other identifying information or links to additional information. This information can include but is not limited to the network address, processing resources at the node, how the shard is stored (compressed, encrypted), the media on which the shard is stored, and the bandwidth connection to the node. The node identifier 243 can include a link to another table containing the additional node information.

In one embodiment, the parameter table 240a is maintained on a coordinating node 210a. However, it is also contemplated that a duplicate parameter table 240a can be stored on another node either for redundancy purposes or for load balancing (serving queries). Further, it is contemplated that the parameter table 240a is dynamically updated after a database update to the data-structure or when a data-structure is split. For example, when a data-structure gets too large, it will be split. Next, the Parameter table 240a needs to be updated with a new data-structure identifier and associated criteria for the new data-structure. If a database is being updated and indexed, the parameter table 240a will need updating. For example, if the parameter is “Time”, then the Criteria 242 will need to be updated to reflect the time the new data is added to a data-structure.

In another embodiment, the parameter table is only updated when an immutable index is mounted. The indices that receive updates are not part of the parameter table.

The parameter table 240a may be sorted periodically to improve searching the table for the relevant data-structures to be searched. For example, if the parameter type 241 is “Time”, the table 240a may be sorted from the most recent time range to the oldest time range. More recent information is likely to be more relevant than older information. For a parameter type of “Geographic Area,” the Criteria 242 may be sorted by distance from a particular database server, or home office location or a specified location.

In another embodiment, the Parameter Table 240a can be comprised of multiple tables (not shown). Each table can be of single parameter type. For example, first table can have the Parmeters for “Time” and the associated information for time criteria for each data-structure and other information such as the node and associated information needed to access the node.

In another embodiment, these parameters are selected, controlled, and specified by the Kibana software user interface provided by Elasticsearch or other software.

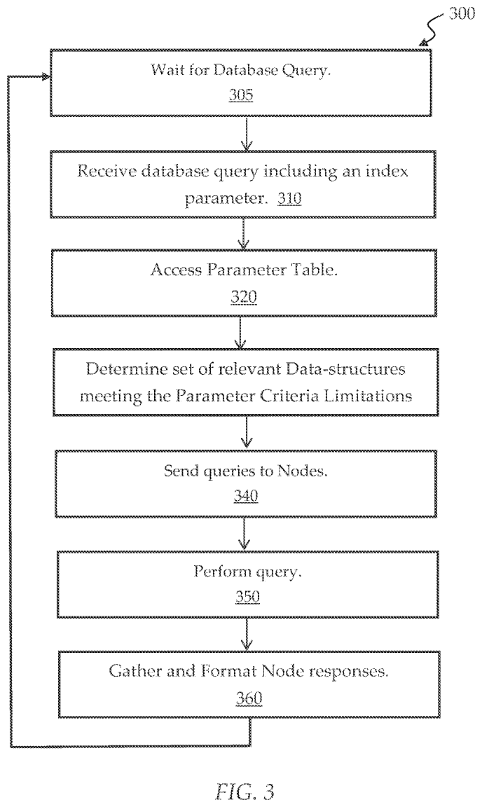

Referring to FIG. 3, a method 300 for processing database queries using parameters to optimize the processing is shown and described. First the method 300 waits for a database query 305.

In step 310, a database query is received. The query includes a parameter and a criteria for the parameter. The query request can be received and served by any of the nodes. The query request can be generated by a user that is coupled to the database software directly, over a local area network (LAN), or over a wide area network (WAN). Further, the query can be generated by higher level user interface software or software management systems.

Based on the query and its associated parameter and criteria, a parameter table 240a-240n is accessed 320 to determine which data-structure and optionally associated nodes overlap the criteria in the query. The parameter access 320 can be to more than one table or any other data structure that contains the parameter type, the parameter criteria, the associated node information (optionally) and associated data-structure identifier.

Next the parameter table(s) is searched to determine the relevant data-structures that meet the criteria in the query. The search will depend on the organization of the parameter table. The number of data-structures is usually small relative to the data-structure size so searching a table of several thousand parameter entries will not be excessive. The parameter table can be organized in a linearly increasing range so that searching can stop when outside of the range. Other data structures than a table are contemplated.

Next, a database query request 340 is sent to each of the nodes that have a shard identified in the parameter table as being relevant. The software making the search request can execute on the same hardware as the node. Alternatively, the software can connect through a LAN, WAN, or through the Internet to make a request.

Next, the process will wait, gather, and format 360 the search responses. Preferably, the responses are organized in a logical order which can be by time range or other factors.

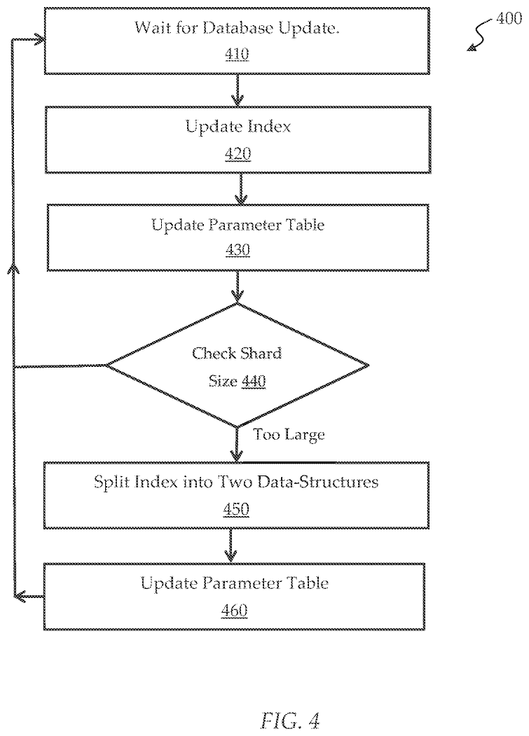

Referring to FIG. 4, a process 400 for managing a Parameter Table is shown and described. In step 410 the process waits for an update to the database. After the update, the database index is updated 420.

Either after a database shard update, or at a scheduled time, or periodically, the parameter table is updated 430. For a time index parameter, the parameter criteria expands and thus the parameter table needs to be updated to reflect this change.

Next, for the data-structure being updated, a check of the database data-structure size 440 is made. The ongoing database updates can be put into the most recent shard. As the database data-structure gets larger, searches on this shard will take longer and require more system resources. Either based on when the data-structure reaches a prespecified size, or based on time, the data-structure can be split. For a data-structure that is a database shard, more information can be found in U.S. patent application Ser. No. 16/176,956, entitled “Shard Splitting” filed Oct. 31, 2018. This application is incorporated by reference.

In step 450, the data-structure is split. The split can create a fixed sized data-structure and a remainder data-structure or two data-structures of equal size.

In step 460, the parameter table will need to be updated to reflect the split data-structure, parameters within each data-structure, the parameter criteria, and optionally nodes associated with the split data-structures. Upon completion, the process repeats.

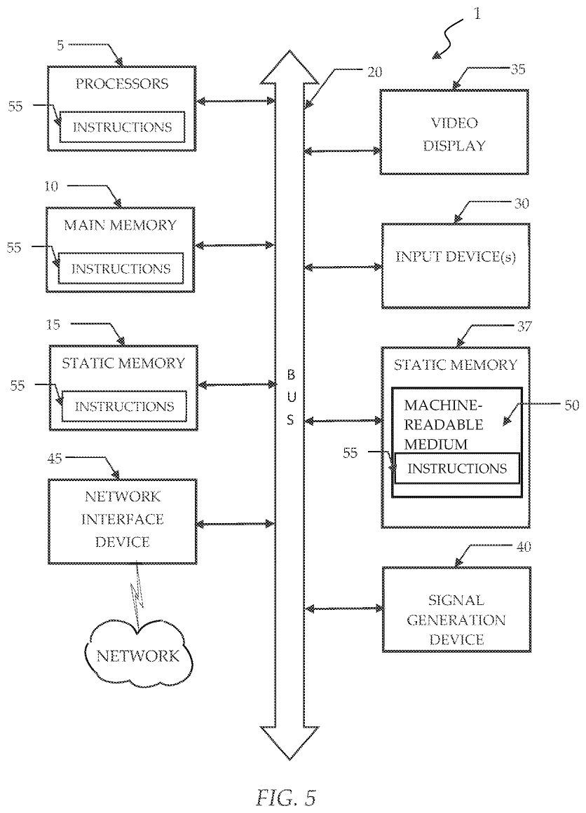

FIG. 5 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be, for example, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), Digital Signal Processor, or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within static memory 15 and/or within the processors 5 during execution thereof by the computer system 1. The main memory 10, static memory 15, and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, section, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purposes only and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A computer-implemented method of querying a searchable database comprised of multiple data-segments:
receiving a database query including at least one index parameter and an index parameter criteria;
accessing a parameter table of data-segments comprising one or more associated index parameters;
determining a set of relevant data-segments from the parameter table meeting the index parameter criteria; and
performing the database query on the set of relevant data-segments.

2. The method of claim 1, wherein the data-segments are comprised of shards and disk partitions.

3. The method of claim 1, wherein the at least one index parameter is a time range.

4. The method of claim 1, wherein the at least one index parameter is a geographic area.

5. The method of claim 1, wherein the computer implemented method is implemented on at least one index parameter includes multiple parameters.

6. The method of claim 1, wherein a coordinator node requests the database query and at least one of the data-segments is on a remote node separate from the coordinator node.

7. The method of claim 6, wherein the parameter table is located on all the nodes and wherein queries can be served by any node.

8. The method of claim 7, further comprising the step of the coordinator node receiving parameter table updates.

9. The method of claim 1, wherein the parameter table is updated when at least one of the data-segments of the database is updated.

10. A system for querying a searchable database comprised of multiple data-segments, the system comprising:
a processor; and
a memory communicatively coupled to the processor, the memory storing instructions executable by the processor to perform a method comprising:
receiving a database query including at least one index parameter and an index parameter criteria;
accessing a parameter table of data-segments comprising one or more associated index parameters;
determining a set of relevant data-segments from the parameter table meeting the index parameter criteria; and
performing a query on the set relevant data-segments.

11. The system of claim 10, wherein the data-segments is one of shards and disk partitions.

12. The system of claim 10, wherein the at least one index parameter is a time range.

13. The system of claim 11, wherein two or more shards contain data from substantially different time ranges.

14. The system of claim 10, wherein the at least one index parameter is a geographic area.

15. The system of claim 10, wherein the computer implemented method is executed on multiple index parameters.

16. The system of claim 11, wherein a coordinator node performs the database query and at least one of the shards is on a remote node separate from the coordinator node.

17. The system of claim 16, wherein the parameter table is located all the nodes and wherein queries can be served by any node.

18. The system of claim 17, wherein the coordinator node receives all parameter table updates.

19. The system of claim 10, wherein the parameter table is updated when at least one of the data-segments of the database is updated.

20. A non-transitory computer-readable storage medium having embodied thereon instructions, which when executed by at least one processor, perform steps of a method, the method comprising: a processor; and
a memory communicatively coupled to the processor, the memory storing instructions executable by the processor to perform a method comprising:
receiving a database query including at least one index parameter and an index parameter range;
accessing a parameter table of shards comprising one or more associated index parameters;
determining a set of relevant shards from the parameter table meeting the index parameter range; and
performing a query on the set relevant shards.
